(19) United States
(12) Patent Application Publication
(10) Pub. No.: US 2024/0401744 A1
(43) Pub. Date: Dec. 5, 2024

(54) HYDROGEN SUPPLY DEVICE, HYDROGEN FUEL CELL DEVICE, AND HYDROGEN CHARGING SYSTEM INCLUDING THE SAME

(71) Applicant: A Eun Yoon, Gwacheon-Si (KR)

(72) Inventor: A Eun Yoon, Gwacheon-Si (KR)

(21) Appl. No.: 18/532,610

(22) Filed: Dec. 7, 2023

(30) Foreign Application Priority Data
Jun. 2, 2023 (KR) 10-2023-0071915

(51) Int. Cl. F17C 5/06; F17C 13/02; H01M 8/04082; H01M 8/0432; H01M 8/04746

(52) U.S. Cl. CPC F17C 5/06; F17C 13/026; H01M 8/04216; H01M 8/0432; H01M 8/04753; F17C 2221/012; F17C 2250/032; F17C 2250/0439; F17C 2250/0636; F17C 2260/042; F17C 2270/0139; F17C 2270/0184; H01M 2250/20

(57) ABSTRACT

A hydrogen charging system may include: a hydrogen fuel cell device configured to receive hydrogen to be driven, a second temperature acquiring unit configured to acquire a second temperature of the hydrogen, and a hydrogen supply device. The hydrogen supply device may include: a storage unit configured to store the hydrogen, a supply unit configured to supply the hydrogen in the storage unit to the hydrogen fuel cell device, a first temperature acquiring unit disposed in the supply unit so as to be configured to acquire a first temperature of the hydrogen supplied to the hydrogen fuel cell device, and a processor configured to control a supply speed of the hydrogen.

### CROSS-REFERENCE TO RELATED APPLICATION

This application claims the benefit of priority to Korean Patent Application No. 10-2023-0071915, filed in the Korean Intellectual Property Office on Jun. 2, 2023, the entire contents of which are incorporated herein by reference.

### TECHNICAL FIELD

The present disclosure relates to a hydrogen supply device, a hydrogen fuel cell device, and a hydrogen charging system including the same.

### BACKGROUND

To safely charge hydrogen into small electric vehicles, high-pressure gas hydrogen is cooled down to −40° C. and supplied at a fixed pressure at a rate that increases according to an atmospheric temperature.

In a process of supplying hydrogen to a specific inner container, internal energy of the container increases and temperature rises due to the Joule-Thomson effect. Then, as a flow rate of supplied hydrogen increases, a rate of temperature increase also increases.

In the case of a hydrogen tank installed in a hydrogen vehicle, there is a maximum allowable temperature of hydrogen. The maximum temperature is determined so as to ensure the safety of the hydrogen vehicle. Accordingly, it is essential to properly cool the supplied hydrogen and adjust a speed of the hydrogen in charging the hydrogen vehicle.

However, there are limitations in efficient hydrogen charging due to factors such as a temperature difference between a hydrogen supply temperature and an ambient temperature, inflows of heat generated in a process of hydrogen flows, and an inability/difficulty to monitor a hydrogen temperature inside the vehicle.

### SUMMARY

The following summary presents a simplified summary of certain features. The summary is not an extensive overview and is not intended to identify key or critical elements.

Systems, apparatuses, and methods are described for a hydrogen supply device. A hydrogen supply device may comprise a hydrogen storage configured to store hydrogen; a hydrogen supply configured to supply the hydrogen in the hydrogen storage to a hydrogen fuel cell device; a first temperature sensor disposed in the hydrogen supply so as to be configured to acquire a temperature of the hydrogen supplied to the hydrogen fuel cell device; and a processor configured to control, based on the acquired temperature of the hydrogen, a supply speed of the hydrogen from the hydrogen storage.

Also, or alternatively, a hydrogen charging system may comprise a hydrogen fuel cell configured to receive hydrogen, and comprising a second temperature sensor configured to acquire a second temperature of the received hydrogen; and a hydrogen supply device. The hydrogen supply device may comprise a hydrogen storage configured to store the hydrogen, a hydrogen supply configured to supply the hydrogen from the hydrogen storage to the hydrogen fuel cell, a first temperature sensor configured to acquire a first temperature of the hydrogen, in the hydrogen supply, being supplied to the hydrogen fuel cell, and a processor configured to control a supply speed of the hydrogen from the hydrogen storage.

Also, or alternatively, a hydrogen fuel cell may comprise a receptacle configured to receive hydrogen from a hydrogen supply; a chamber configured to store the received hydrogen; a connection unit between the receptacle and the chamber, wherein the connection is configured to allow the hydrogen to flow from the receptacle to the chamber; and a second temperature sensor configured to acquire a temperature of the hydrogen entering the chamber from the connection.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a schematic view of a hydrogen charging system according to an example of the present disclosure;

FIG. 2 is a flowchart illustrating a method for controlling a hydrogen charging speed of a hydrogen charging system according to an example of the present disclosure; and

FIGS. 3 and 4 are tables illustrating a plurality of hydrogen temperature ranges provided to be preset in a processor of a hydrogen supply device, and supply speeds corresponding to the temperature ranges.

### DETAILED DESCRIPTION

Hereinafter, examples of the present disclosure will be described with reference to the accompanying drawings so that an person of ordinary skill in the art, to which the present disclosure pertains, may easily carry out the present disclosure. The following description is one of several aspects of the examples, and in a description of an example, a detailed description of known functions and configurations will be omitted to make the essence of the present disclosure clear.

In the specification, in adding the reference numerals to the components of the drawings, the same or similar components will be denoted by the same or similar reference numerals throughout the specification. The components included in one example and the components including common functions will be described by using the same names in the other examples. The terms or wordings used in the specification and the claims should not be restricted to general or lexical meaning for construction, and should be construed as meanings and concepts that agree with the technical spirits of the present disclosure based on a principle that the inventor(s) may properly define the concepts of the terms to explain the present subject matter in a best way.

Furthermore, the present disclosure is not limited to the examples disclosed herein. A person of ordinary skill in the art, to which the present disclosure pertains, may make various substitutions, variation, and/or modifications from the present description. Therefore, the spirit of the present disclosure should not be restricted to the examples disclosed herein, and all equivalents to the claims fall within the scope of the spirit of the present disclosure.

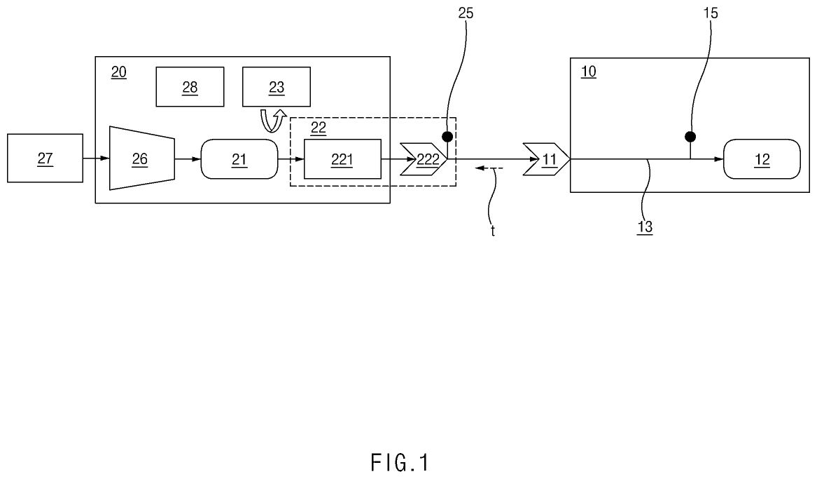

FIG. 1 illustrates a schematic view of a hydrogen charging system according to an example of the present disclosure.

Referring to FIG. 1, a hydrogen charging system according to an example of the present disclosure may include a hydrogen fuel cell device 10 and a hydrogen supply device 20.

The hydrogen fuel cell device 10 may be a device configured to receive hydrogen (e.g., as fuel, so as to be driven). The hydrogen fuel cell device 10, for example, may be a device powered by a hydrogen fuel cell, such as a hydrogen fuel cell vehicle, a hydrogen fuel cell drone, and/or a hydrogen fuel cell power plant, etc. The hydrogen fuel cell device 10 is not limited to the above-described example, and any device that uses a fuel cell that generates electricity via a reaction of hydrogen and oxygen as a power source may correspond thereto. The hydrogen fuel cell device 10 may receive hydrogen from the hydrogen supply device 20 to be driven.

The hydrogen supply device 20 may be configured to supply hydrogen to the hydrogen fuel cell device 10. The hydrogen supply device 20 may include a storage unit 21 (e.g., a hydrogen storage, a hydrogen tank, a hydrogen container, etc.), a supply unit 22 (a hydrogen supply, a hydrogen tank, etc.), a cooling unit 23 (e.g., a cooler, a refrigerator, a condenser) a first temperature acquiring unit 25 (e.g., a temperature sensor and/or thermometer), and a processor 28.

The storage unit 21 may (e.g., be configured to) store hydrogen to be is supplied to the hydrogen fuel cell device 10. Hydrogen that is compressed to a high pressure may be stored in the storage unit 21. The hydrogen stored in the storage unit 21 may be maintained, for example, at a pressure of around 875 bars. A “around” a stated value, herein, may refer to an allowable range comprising the stated value, such as +/−30%, +/−20%, +/−10%, +/−5%, +/−2%, +/−1%, etc.

The supply unit 22 may be configured to supply the hydrogen stored in (e.g., from) the storage unit 21 to the hydrogen fuel cell device 10. The supply unit 22 may include a dispenser 221 and a supply nozzle 222.

The dispenser 221 may be configured to deliver the hydrogen stored in the storage unit 21 to the hydrogen fuel cell device 10. The dispenser 221 may cause gaseous hydrogen of a high pressure to flow from the storage unit 21 to the hydrogen fuel cell device 10. In a process of delivering the hydrogen, the dispenser 221 may adjust a pressure, a temperature, and a flow rate of the hydrogen such that the hydrogen of a high pressure stored in the storage unit 21 safely flows to the hydrogen fuel cell device 10.

The supply nozzle 222 may be connected to the dispenser 221. The hydrogen supplied to the hydrogen fuel cell device 10 may flow to an interior of the supply nozzle 222. The supply nozzle 222 may function as a passage between the dispenser 221 and the hydrogen fuel cell device 10. The supply nozzle 222, for example, may be provided in a form of a charging gun that is coupled to the receptacle unit of the hydrogen fuel cell device, but is not limited thereto.

The cooling unit 23 may be configured to cool the hydrogen to a preset (e.g., predetermined) temperature. The cooling unit 23, for example, may be disposed between the storage unit 21 and the supply unit 22. The cooling unit 23 may be disposed adjacent to the storage unit 21 (e.g., disposed so as to be configured to cool the hydrogen that flows from the storage unit 21 to the supply unit 22 and/or directly cool the hydrogen stored in the storage unit 21.

The first temperature acquiring unit 25 may be configured to acquire a temperature of the hydrogen supplied to the hydrogen fuel cell device 10. The first temperature acquiring unit 25 may be a temperature sensor. The first temperature acquiring unit 25 may be disposed in the supply unit 22, and may acquire a first temperature of the hydrogen that flows to the supply unit 22. The first temperature acquiring unit 25 may be disposed in the supply nozzle 222 of the supply unit 22. The first temperature acquiring unit 25, for example, may be embedded in an interior of the supply nozzle 222 that is provided in a charging gun, in a form of a temperature sensor. By employing a configuration, in which the first temperature acquiring unit 25 is disposed in (and/or otherwise disposed so as to be able to measure the temperature in) the supply nozzle 222, a temperature of the hydrogen supplied to the hydrogen fuel cell device 10 may be acquired at a location that is closest to the hydrogen fuel cell device 10. That is, as compared with a case in which the first temperature acquiring unit 25 is disposed at (and/or so as to measure at) another location of the hydrogen supply device 20, a change in a temperature of the hydrogen due to heat loss that occurs in a path of the hydrogen may be minimized if the first flow temperature acquiring unit 25 is disposed in (and/or so as to measure the temperature in) the supply nozzle 222. A difference between the acquired temperature of the hydrogen and a temperature of the hydrogen supplied to the hydrogen fuel cell device 10 may be substantially reduced relative to other configurations.

For example, if the first temperature acquiring unit 25 is disposed not in the supply nozzle 222 of the supply unit 22, but in the cooling unit 23 (and/or so as to measure hydrogen nearest to the cooling unit 23), a temperature of the hydrogen that flows in the supply nozzle 222 directly coupled to the receptacle unit 11 of the hydrogen fuel cell device 10 and a temperature of the hydrogen, which is acquired by the first temperature acquiring unit 25 disposed in the cooling unit 23, may be different. If the first temperature acquiring unit 25 is disposed in (and/or so as to measure a temperature of hydrogen in) an interior of the supply nozzle 222, as in the present disclosure, an accurate temperature of the hydrogen supplied to the receptacle unit 11 of the hydrogen fuel cell device 10 may be acquired.

The processor 28 may be configured to control a supply speed of the hydrogen supplied to the hydrogen fuel cell device 10. The processor 28 may include software that is programmed to control the supply speed of the hydrogen (e.g., in advance and/or during supplying), hardware that is physically/electrically connected to the supply unit 22 to control it, or a combination thereof.

The processor 28 may control the supply speed of the hydrogen based on the first temperature acquired by the first temperature acquiring unit 25. As described above, if the first temperature acquiring unit 25 is disposed in the supply nozzle 222 of the supply unit 22, the acquired first temperature may be a temperature of the hydrogen that flows to the interior of the supply nozzle 222. The processor 28 may be physically and/or electrically (e.g., communicatively) connected to the first temperature acquiring unit 25, so as to be configured to acquire the first temperature of the hydrogen from the first temperature acquiring unit 25. Also, or alternatively, the processor 28 may include a communication part (e.g., receiver, transceiver, transmitter, interface, etc.) that may be configured to request and/or receive the first temperature from the first temperature acquiring unit 25.

The processor 28 may be configured to control the supply speed of the hydrogen such that the supply speed of the hydrogen decreases if the first temperature of the hydrogen acquired by the first temperature acquiring unit 25 increase, and/or such that the supply speed of the hydrogen increases if the first temperature decreases.

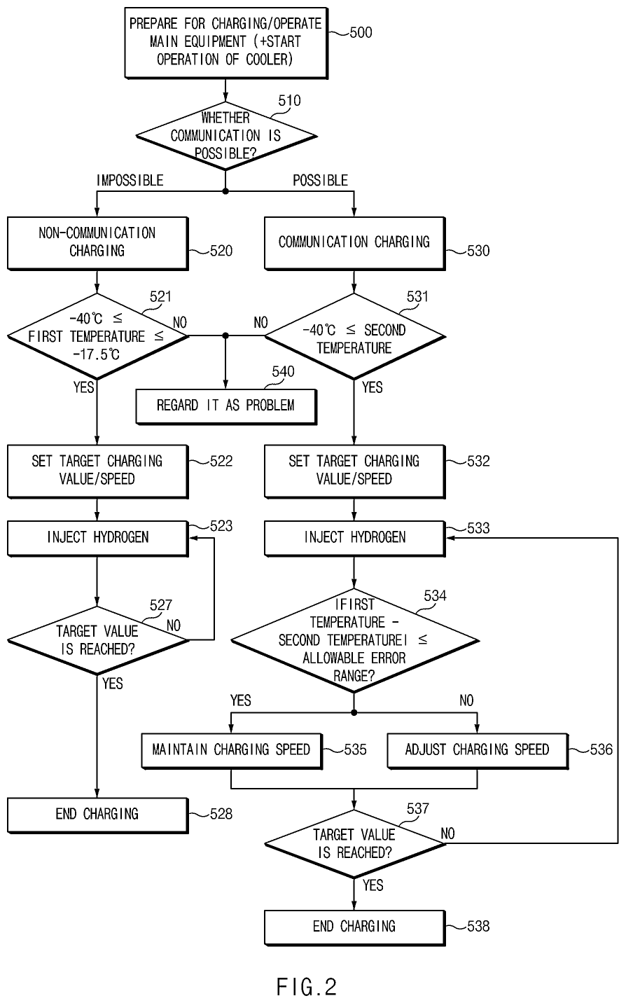

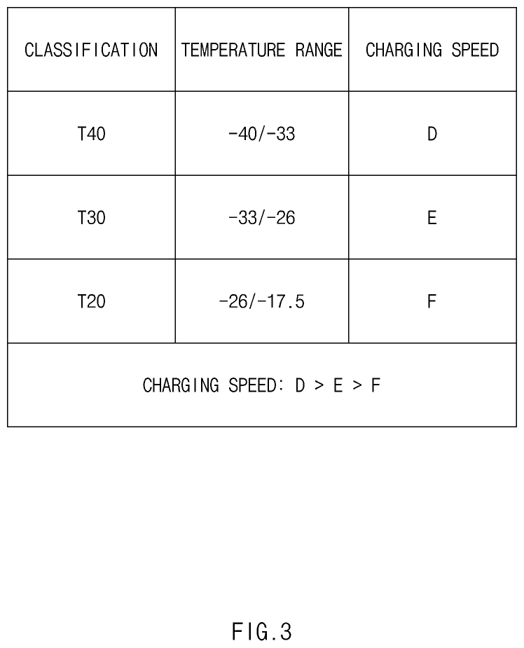

The processor 28 may be provided with a preset algorithm for the supply speed of the hydrogen. For example, the processor 28 may be in a state, in which a plurality of hydrogen temperature ranges and supply speeds corresponding to the temperature ranges are preset. Accordingly, the supply speed of the hydrogen may be controlled with reference to a temperature range, to which the first temperature of the hydrogen acquired by the first temperature acquiring unit 25 pertains, and detailed contents for the method for controlling the supply speed of the hydrogen will be described in detail with reference to FIGS. 2 and 3.

The hydrogen supply device 20 of the hydrogen charging system according to an example of the present disclosure may further include a compression unit 26.

The compression unit 26 (e.g., compressor) may receive the hydrogen from a transportation unit 27 that is configured to transport/supply hydrogen that is to be stored in the hydrogen supply device 20. The compression unit 26 may compress the hydrogen to a preset pressure such that the hydrogen is compressed and stored in the storage unit 21. For example, the compression unit 26 may boost a pressure of the hydrogen supplied from the transportation unit 27 at a pressure of 200 bars to 450 bars to a pressure of 700 bars to 900 bars and may deliver the hydrogen to the storage unit 21.

The hydrogen fuel cell device 10 of the hydrogen charging system according to an example of the present disclosure may include a receptacle unit 11 (e.g., a receptacle), a chamber unit 12 (e.g., a chamber), a connection unit 13 (e.g., a connector, a conduit, etc.), and a second temperature acquiring unit 15 (e.g., a temperature sensor and/or thermometer).

The receptacle unit 11 may be connected to the supply nozzle 222 of the hydrogen supply device 20, and may be configured to receive the hydrogen from the supply nozzle 222. The receptacle unit 11, for example, may be in a form, in which it may be coupled to the supply nozzle 222 in a form of a charging gun. If the hydrogen fuel cell device 10 is for a hydrogen fuel cell vehicle, the receptacle unit 11 may be provided in a form of a filling port that is coupled to the charging gun.

The chamber unit 12 may be configured to store the hydrogen received through the receptacle unit 11. The hydrogen fuel cell device 10 may be driven by the hydrogen stored in the chamber unit 12 as a fuel. The hydrogen received via the hydrogen supply device 20 may be stored in the chamber unit 12 of the hydrogen fuel cell device 10. For stable storage and use of the hydrogen, the hydrogen stored in the chamber unit 12 may be maintained at a preset temperature (for example, around 85° C. or less).

The connection unit 13 may connect the receptacle unit 11 and the chamber unit 12 such that the hydrogen flows from the receptacle unit 11 to the chamber unit 12. The hydrogen supplied from the supply nozzle 222 of the hydrogen supply device 20 to the receptacle unit 11 may be stored in the chamber unit 12 through the connection unit 13. For example, if the hydrogen fuel cell device 10 is for a hydrogen fuel cell vehicle, the connection unit 13 may be a supply pipeline between a receptacle and a hydrogen tank of the vehicle.

The second temperature acquiring unit 15 may be configured to sense the second temperature of the hydrogen supplied to the chamber unit 12. The second temperature acquiring unit 15, for example, may be in a form of a temperature sensor and/or thermometer. The second temperature acquiring unit 15 may be disposed in the connection unit 13 that connects the receptacle unit 11 and the chamber unit 12. As described above, the temperature of the hydrogen stored in the chamber unit 12 may be maintained at a preset temperature or less. The second temperature acquiring unit 15 may be disposed in (e.g., so as to be able to measure a temperature in) the connection unit 13 whereby the second temperature acquiring unit 15 may acquire the second temperature of the hydrogen introduced into the chamber unit 12.

A communication “t” may exist from the hydrogen fuel cell device 10 to the hydrogen supply device 20. The processor 28 of the hydrogen supply device 20 may acquire the second temperature of the hydrogen via the communication “t”. In other words, the second temperature acquired by the second temperature acquiring unit 15 may be transmitted to the processor 28 of the hydrogen supply device 20 via the communication between the hydrogen fuel cell device 10 and the hydrogen supply device 20. The communication “t” between the hydrogen fuel cell device 10 and the hydrogen supply device 20 may be possible, even if it is a unidirectional communication that faces from the hydrogen fuel cell device 10 to the hydrogen supply device 20.

Based on (e.g., if) the processor 28 being able to acquire the second temperature of the second temperature acquiring unit 15, the supply speed of the hydrogen may be controlled based on the second temperature and the first temperature. If the communication “t” between the hydrogen fuel cell device 10 and the hydrogen supply device 20 is not possible (e.g., does not exist), the processor 28 may be configured to control the supply speed of the hydrogen based on the first temperature acquired by the first temperature acquiring unit 25 (e.g., as described herein). A method for controlling the supply speed of the hydrogen will be described in detail hereinafter.

FIG. 2 is a flowchart illustrating a method for controlling a hydrogen charging speed of the hydrogen charging system according to an example of the present disclosure.

Referring to FIG. 2, the method for controlling the hydrogen charging speed of the hydrogen charging system according to an example of the present disclosure may be largely divided into two tracks with reference to whether the communication between the hydrogen supply device 20 and the hydrogen fuel cell device 10 is possible. The hydrogen charging speed may be controlled by the processor 28 of the hydrogen supply device 20.

A charging preparing and equipment operating operation 500 may comprise parts of the hydrogen supply device 20, such as the processor 28 and the supply unit 22, being started to supply hydrogen. The cooling unit 23 also may be driven to cool the hydrogen.

According to whether the communication between the hydrogen supply device 20 and the hydrogen fuel cell device 10 is possible (510), a communication charging (530) process may be performed (e.g., based on the communication being possible) and a non-communication charging (520) process may be performed (e.g., based on the communication not being possible). The communication, as described herein, may be a unidirectional communication from the hydrogen fuel cell device 10 to the hydrogen supply device 20.

In the non-communication charging 520, in which the communication between the hydrogen supply device 20 and the hydrogen fuel cell device 10 is not possible, the processor 28 of the hydrogen supply device 20 may not acquire the second temperature of the hydrogen fuel cell device 10. The hydrogen charging speed may be controlled based on the first temperature (e.g., without a second temperature as described herein).

In the non-communication charging 520, an operation 521 of determining a temperature range of the first temperature may comprise determining that the first temperature pertains to (e.g., falls within) a preset range. The preset temperature range, for example, may be a temperature of not less than −40° C. and not more than −17.5° C. If the first temperature does not pertain to the corresponding temperature range, the process may proceed to a problem generation regarding operation 540 (e.g., a problem may be determined). The charging may be stopped and/or the charging speed may be significantly decreased. For example, a detected problem may correspond to an electrical problem with the first temperature acquiring unit 25 (e.g., provided in a form of a temperature sensor) such that a sensing error occurs and/or a driving defect of the cooling unit 23 that causes the temperature of the hydrogen to increase or decrease to an abnormal (e.g., unexpected, undesired) range/level.

The charging may be ended (528), for example, after an operation 522 of setting a charging speed and a target charging value (charging amount). For example, the charging speed may be ended (528) if the first temperature pertains to the preset temperature range such that an operation 523 of injecting the hydrogen and an operation 527 of determining whether the charging amount of the hydrogen reaches a target value indicates that the target value was reached.

In the operation 522 of setting the charging speed and/or the target charging value, the charging speed of the hydrogen may be changed according to the temperature range to which the first temperature pertains. See, for example, FIG. 3, and related description herein.

In the communication charging 530, in which the communication between the hydrogen supply device 20 and the hydrogen fuel cell device 10 is possible, the processor 28 of the hydrogen supply device 20 may acquire the second temperature of the hydrogen fuel cell device 10. In this case, the supply speed of the hydrogen may be controlled based on the second temperature and the first temperature.

In the communication charging 530, a temperature range of the second temperature may be determined (531). It may be determined whether the second temperature pertains to (e.g., falls within) the preset range. Here, the preset temperature range, for example, may be a temperature of around −40° C. or more. If the second temperature is determined not to pertain to the corresponding temperature range, the process may proceed to the problem generation regarding operation 540 (e.g., to stop the charging and/or significantly decrease the charging speed, e.g., until the problem can be identified and/or dealt with). For example, if an electrical problem occurs in the second temperature acquiring unit 15 (e.g., provided in an interior of the hydrogen fuel cell device 10 in a form of a temperature sensor), a sensing error may occur, and the problem generation operation 540 may be performed based on the detected sensing error/temperature abnormality.

If the second temperature acquired by the second temperature acquiring unit 15 pertains to (e.g., falls within) the preset temperature range, the process may proceed to an operation 533 of injecting the hydrogen after the operation 532 of setting the charging speed and the target charging value (charging amount) according to the temperature range of the second temperature.

In the process of injecting the hydrogen, it may be determined (534) whether a difference between the first temperature and the second temperature pertains to an allowable range. If the difference between the first temperature and the second temperature is more than (e.g., exceeds) a preset temperature difference range, the first temperature acquiring unit 25 and/or the second temperature acquiring unit 15 may be abnormal. The charging speed may be readjusted via a charging speed adjusting operation 536 (e.g., based on the difference exceeding the preset temperature difference range. For example, the supply speed may significantly decrease via the charging speed adjusting operation 536. If the difference between the first temperature and the second temperature is in the preset temperature difference range, it may be determined that no change in charging speed is necessary and the charging speed may be maintained (535).

The charging may be ended (538) based on the operation 537 of determining whether the charging amount of the hydrogen reaches the target value (e.g., based on the charging amount is determined to have reached the target value in 537). If the charging amount of the hydrogen is not determined to have reached the target value, the operation 533 of injecting the hydrogen, the operation 534 of determining whether the difference between the first temperature and the second temperature pertains to the allowable range, and the operations 535 and 536 of maintaining or adjusting the charging speed may be performed again.

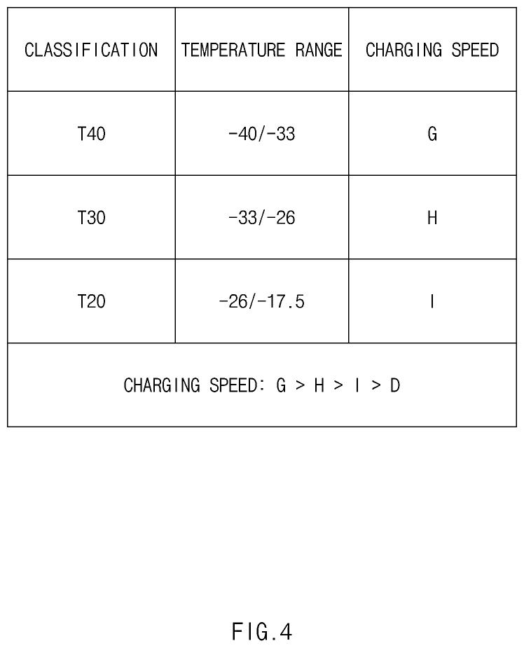

FIGS. 3 and 4 are tables illustrating a plurality of hydrogen temperature ranges provided to be preset in the processor 28 of the hydrogen supply device 20, and supply speeds corresponding to the temperature ranges.

FIG. 3 illustrates non-communication charging, in which the communication between the hydrogen fuel cell device 10 and the hydrogen supply device 20 is not performed, and FIG. 4 illustrates communication charging, in which the communication between the hydrogen fuel cell device 10 and the hydrogen supply device 20 is performed.

Referring to FIGS. 3 and 4, for example, the allowed temperature range of the hydrogen may be divided into three temperature ranges. The temperature range may be divided into a temperature range T40 of not less than −40° C. and not more than −33° C., a temperature range T30 of not less than −33° C. and not more than −26° C., and a temperature range T20 of not less than −26° C. and not more than −17.5° C.

Referring to FIG. 3, if the first temperature of the hydrogen, which is acquired from the first temperature acquiring unit 25 pertains to the temperature range T40 of not less than −40° C. and not more than −33° C., the supply speed of the hydrogen may be controlled to a speed “D” corresponding to the corresponding temperature range, if the first temperature pertains to the temperature range T30 of not less than −33° C. and not more than −26° C., the supply speed of the hydrogen may be controlled to a speed “E” corresponding to the corresponding temperature range, and if the first temperature pertains to the temperature range T20 of not less than −26° C. and not more than −17.5° C., the supply speed of the hydrogen may be controlled to a speed “F” corresponding to the corresponding temperature range. Then, the supply speed “D” of the hydrogen corresponding to the lowest temperature range T40 may have a highest value and the supply speed “F” of the hydrogen corresponding to the highest temperature range T20 may have a lowest value such that the supply speed of the hydrogen decreases as the first temperature of the hydrogen increases.

Referring to FIG. 4, if the second temperature of the hydrogen, which is acquired from the second temperature acquiring unit 15 pertains to the temperature range T40 of not less than −40° C. and not more than −33° C., the supply speed of the hydrogen may be controlled to a speed “G” corresponding to the corresponding temperature range, if the first temperature pertains to the temperature range T30 of not less than −33° C. and not more than −26° C., the supply speed of the hydrogen may be controlled to a speed “H” corresponding to the corresponding temperature range, and if the first temperature pertains to the temperature range T20 of not less than −26° C. and not more than −17.5° C., the supply speed of the hydrogen may be controlled to a speed “I” corresponding to the corresponding temperature range. Then, the supply speed “G” of the hydrogen corresponding to the lowest temperature range T40 may have a highest value and the supply speed “I” of the hydrogen corresponding to the highest temperature range T20 may have a lowest value such that the supply speed of the hydrogen decreases as the second temperature of the hydrogen increases.

However, in the communication charging between the hydrogen fuel cell device 10 and the hydrogen supply device 20, the supply speed of the hydrogen is controlled with reference to the second temperature acquired by the second temperature acquiring unit 15 disposed in an interior of the hydrogen fuel cell device 10 whereby the supply speed “I” of the hydrogen may be higher than the supply speed “D” in the non-communication charging even if the second temperature pertains to the highest temperature range T20.

The present disclosure has been made to solve the above-mentioned problems, and/or other problems, occurring in the prior art while maintaining advantages achieved by the prior art.

An aspect of the present disclosure provides a hydrogen charging system that may acquire a temperature of hydrogen supplied to a hydrogen fuel cell device and may optimize a supply speed of the hydrogen based on the acquired temperature of the hydrogen.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a hydrogen supply device may include (e.g., comprise) a storage unit that stores hydrogen, a supply unit that supplies the hydrogen in the storage unit to a hydrogen fuel cell device, a first temperature acquiring unit disposed in the supply unit to acquire a temperature of the hydrogen supplied to the hydrogen fuel cell device, and a processor that controls a supply speed of the hydrogen based on the temperature of the hydrogen, which is acquired by the first temperature acquiring unit.

The supply unit may include a dispenser that causes the hydrogen in the storage unit to flow the hydrogen fuel cell device, and a supply nozzle connected to the dispenser and that causes the hydrogen supplied to the hydrogen fuel cell device to flow, and the first temperature acquiring unit may be disposed in the supply nozzle to acquire a first temperature of the hydrogen supplied to the hydrogen fuel cell device.

The processor may control the supply speed of the hydrogen such that the supply speed of the hydrogen decreases if the acquired first temperature increases.

The processor may determine, among a plurality of preset temperature ranges, a temperature range, to which the acquired first temperature pertains, and controls the supply speed of the hydrogen to a preset supply speed corresponding to the temperature range.

According to another aspect of the present disclosure, a hydrogen charging system may comprise a hydrogen fuel cell device that receives hydrogen to be driven, and including a second temperature acquiring unit that acquires a second temperature of the hydrogen, and a hydrogen supply device including a storage unit that stores the hydrogen, a supply unit that supplies the hydrogen in the storage unit to the hydrogen fuel cell device, a first temperature acquiring unit disposed in the supply unit to acquire a first temperature of the hydrogen supplied to the hydrogen fuel cell device, and a processor that controls a supply speed of the hydrogen.

The hydrogen fuel cell device may further include a receptacle unit connected to the supply unit to receive the hydrogen from the supply unit, a chamber unit that stores the received hydrogen,, and a connection unit connecting the receptacle unit and the chamber unit such that the hydrogen flows from the receptacle unit to the chamber unit, and the second temperature acquiring unit is disposed on the connection unit.

The processor may acquire the second temperature from the second temperature acquiring unit of the hydrogen fuel cell device.

The processor may control the supply speed of the hydrogen based on the second temperature.

The processor may control the supply speed of the hydrogen based on the acquired second temperature, and decreases the supply speed of the hydrogen if a difference between the first temperature and the second temperature is more than a preset range.

According to an aspect of the present disclosure, a hydrogen fuel cell device that receives hydrogen to be driven may comprise a receptacle unit that receives the hydrogen from a hydrogen supply device, a chamber unit that stores the received hydrogen, a connection unit connecting the receptacle unit and the chamber unit such that the hydrogen flows from the receptacle unit to the chamber unit, and a second temperature acquiring unit disposed in the connection unit to acquire a temperature of the hydrogen that faces the chamber unit.

It is noted that classification of the temperature ranges and the temperature values of the hydrogen may be properly changed according to the various kinds of the hydrogen fuel cell device, and are not limited to the above description.

The hydrogen charging system according to the example of the present disclosure may acquire a temperature of hydrogen supplied to the hydrogen fuel cell device and may optimize a supply speed of the hydrogen based on the acquired temperature of the hydrogen.

In addition, effects that may be easily predicted by an person of ordinary skill in the art from the configurations according to the examples of the present disclosure disclosed herein may be included.

Although the present disclosure has been described with reference to the limited examples and the drawings in the above description, the above description is simply an exemplary description of the technical spirits of the present disclosure, and an person of ordinary skill in the art, to which the present disclosure pertains, may make various corrections and modifications without departing from the essential characteristics of the present disclosure.

Therefore, the examples disclosed in the present disclosure are not for limiting the technical spirits of the present disclosure but for describing them, and the scope of the technical spirits of the present disclosure is not limited by the examples. The protection scope of the present disclosure should be construed by the following claims, and all the technical spirits in the equivalent range should be construed as being included in the scope of the present disclosure.

What is claimed is:

1. A hydrogen supply device comprising:
a hydrogen storage configured to store hydrogen;
a hydrogen supply configured to supply the hydrogen in the hydrogen storage to a hydrogen fuel cell device;
a first temperature sensor disposed in the hydrogen supply so as to be configured to determine a temperature of the hydrogen supplied to the hydrogen fuel cell device; and
a processor configured to control, based on the determined temperature of the hydrogen, a supply speed of the hydrogen from the hydrogen storage.

2. The hydrogen supply device of claim 1, wherein the hydrogen supply comprises:
a dispenser configured to cause the hydrogen in the hydrogen storage to flow to the hydrogen fuel cell device; and
a supply nozzle connected to the dispenser and configured to cause the hydrogen that flows, via the dispenser to the hydrogen fuel cell device, to flow into the hydrogen fuel cell device so as to be supplied to the hydrogen fuel cell device,
wherein the first temperature sensor is disposed to determine a first temperature of the hydrogen, in the supply nozzle, being supplied to the hydrogen fuel cell device.

3. The hydrogen supply device of claim 2, wherein the processor is configured to control the supply speed of the hydrogen to decrease the supply speed of the hydrogen based on an increase in the determined first temperature.

4. The hydrogen supply device of claim 3, wherein the processor is configured to:
determine, among a plurality of predetermined temperature ranges, a temperature range to which the determined first temperature pertains; and
control the supply speed of the hydrogen to a predetermined supply speed corresponding to the temperature range.

5. A hydrogen charging system comprising:
a hydrogen fuel cell configured to receive hydrogen, and comprising a second temperature sensor configured to determine a second temperature of the received hydrogen; and
a hydrogen supply device comprising:
a hydrogen storage configured to store the hydrogen,
a hydrogen supply configured to supply the hydrogen from the hydrogen storage to the hydrogen fuel cell,
a first temperature sensor configured to determine a first temperature of the hydrogen, in the hydrogen supply, being supplied to the hydrogen fuel cell, and
a processor configured to control a supply speed of the hydrogen from the hydrogen storage.

6. The hydrogen charging system of claim 5, wherein the hydrogen fuel cell further comprises:
a receptacle connected to the hydrogen supply so as to receive the hydrogen from the hydrogen supply;
a chamber configured to store the received hydrogen; and
a connector between the receptacle and the chamber, wherein the connector is configured to allow the hydrogen to flow from the receptacle to the chamber,
wherein the second temperature sensor is configured to determine the second temperature of the received hydrogen from within the connector.

7. The hydrogen charging system of claim 5, wherein the processor is configured to receive the second temperature from the second temperature sensor.

8. The hydrogen charging system of claim 7, wherein the processor is configured to control, based on the second temperature, the supply speed of the hydrogen.

9. The hydrogen charging system of claim 7, wherein the processor is configured to control, based on the determined second temperatures, the supply speed of the hydrogen and wherein the processor is configured to, based on a difference between the first temperature and the second temperature exceeding a predetermined temperature difference, decrease the supply speed of the hydrogen.

10. A hydrogen fuel cell comprising:
a receptacle configured to receive hydrogen from a hydrogen supply;
a chamber configured to store the received hydrogen;
a connector between the receptacle and the chamber, wherein the connection is configured to allow the hydrogen to flow from the receptacle to the chamber; and
a second temperature sensor configured to determine temperature of the hydrogen entering the chamber from the connection.
